(19) United States
(12) Patent Application Publication
(10) Pub. No.: US 2026/0064174 A1
(43) Pub. Date: Mar. 5, 2026

(54) Power Supply Units in Server Computers

(71) Applicant: Super Micro Computer, Inc., San Jose, CA (US)

(72) Inventors: CHEN-CHIEH CHEN, New Taipei City (TW); SHIH BIN LIN, New Taipei City (TW)

(21) Appl. No.: 18/821,170

(22) Filed: Aug. 30, 2024

(51) Int. Cl. G06F 1/26

(52) U.S. Cl. CPC G06F 1/263

(57) ABSTRACT

This application is directed to an electronic system that uses multiple power supply signals. The electronic system includes a first power interface for receiving a first power supply signal, a second power interface for receiving a second power supply signal, a power converter, and a controller. The power converter is configured to generate a plurality of DC power supplies based on at least one of the first power supply signal and the second power supply signal. The controller is configured to control the first power interface and the second power interface and select the at least one of the first power supply signal and the second power supply signal to generate the plurality of DC power supplies. Each of the first and second power interfaces may have a power switch and be controlled to provide a respective power supply signal to the power converter.

### TECHNICAL FIELD

This application relates generally to power technology including, but not limited to, methods, apparatuses, structures, devices, and systems for providing power to server computers.

### BACKGROUND

A power supply unit (PSU) of a server is required to provide excessive power, particularly for intensive tasks such as machine learning. High power draw from multiple GPUs, CPUs, and other components can overload the PSU, leading to system instability, random shutdowns, or complete failure to boot. The continuous high demand also generates significant heat, which can overwhelm standard cooling solutions, resulting in overheating and thermal throttling. These conditions not only reduce performance but can also prematurely age the PSU, necessitating more frequent replacements and increasing maintenance costs. Additionally, excessive power requirements can strain the PSU's voltage regulation capabilities, causing fluctuating voltages that may lead to system crashes or component failures. The increased power draw and subsequent heat generation can also contribute to higher energy costs and potential overcurrent situations, posing safety hazards.

### SUMMARY

Various embodiments of this application are directed to methods, apparatuses, structures, devices, and systems for providing power to a server system (e.g., including an artificial intelligence server). The server system may implement large amounts of high-speed computational operations, thereby demanding a substantially high power level (e.g., greater than a threshold power level, >5 kilowatts (KW)). In accordance with at least some embodiments disclosed herein is the realization that several critical issues can arise when a power supply unit (PSU) of a server needs to provide the substantially high power level power (e.g., 6 KW), particularly for intensive tasks such as machine learning. Some implementations of this application are directed to mitigating the risks associated with the server that demands excessive power by using high-capacity and high-quality PSUs jointly with intelligent power management, thereby ensuring stability and reliability in high-performance server environments (e.g., in data centers that implement machine learning tasks). In some embodiments, a server uses one or more PSUs each of which is configured to receive a plurality of alternating current (AC) or direct current (DC) power inputs and provide a plurality of output voltages to satisfy a power demand of the server in an efficient and reliable manner.

In one aspect, some implementations include an electronic system. The electronic system includes a first power interface for receiving a first power supply signal, a second power interface for receiving a second power supply signal, a power converter coupled to the first power interface and the second power interface, and a controller coupled to at least the first power interface, and the second power interface. The power converter is configured to generate a plurality of DC power supplies based on at least one of the first power supply signal and the second power supply signal. The controller is configured to select the at least one of the first power supply signal and the second power supply signal via the first power interface and the second power interface independently of each other to be input into the power convert for generating the plurality of DC power supplies.

In some implementations, each of the first power interface and the second power interface further includes a power switch coupled to the controller, and the power switch is configured to receive a respective power control signal from the controller and connect the respective power interface to provide the first power supply signal or the second power supply signal to the power converter.

In some embodiments, each of the first power supply signal and the second power supply signal includes a respective DC power supply.

In some embodiments, the first power supply signal corresponds to an AC signal having a first phase, and the second power supply signal corresponds to an alternating current signal having a second phase that is offset from the first phase by one-third of a power signal cycle.

In another aspect, some implementations include a server power system. The server power system includes a first power interface for receiving a first power supply signal, a second power interface for receiving a second power supply signal, a power converter coupled to the first power interface and the second power interface, and a controller coupled to the power converter, the first power interface, and the second power interface. The power converter is configured to generate a plurality of DC power supplies based on at least one of the first power supply signal and the second power supply signal. The controller is configured to control the first power interface and the second power interface independently of each other and select the at least one of the first power supply signal and the second power supply signal to generate the plurality of DC power supplies.

In yet another aspect, a method is implemented for providing an electronic system or a server power system. The method includes providing a first power interface for receiving a first power supply signal, providing a second power interface for receiving a second power supply signal, providing a power converter coupled to the first power interface and the second power interface, and providing a controller coupled to at least the first power interface, and the second power interface. The power converter is configured to generate a plurality of DC power supplies based on at least one of the first power supply signal and the second power supply signal. The controller is configured to select the at least one of the first power supply signal and the second power supply signal via the first power interface and the second power interface independently of each other to be input into the power convert for generating the plurality of DC power supplies.

In another aspect, a method is implemented for powering an electronic system. The method includes receiving a first power supply signal; receiving a second power supply signal; while controlling the first power interface and the second power interface independently of each other, selecting at least one of the first power supply signal and the second power supply signal; and generating a plurality of DC power supplies based on the at least one of the first power supply signal and the second power supply signal.

These illustrative embodiments and implementations are mentioned not to limit or define the disclosure, but to provide examples to aid understanding thereof.

Additional embodiments are discussed in the Detailed Description, and further description is provided there.

### BRIEF DESCRIPTION OF THE DRAWINGS

For a better understanding of the various described implementations, reference should be made to the Detailed Description below, in conjunction with the following drawings in which like reference numerals refer to corresponding parts throughout the figures.

FIG. 1 is a front view of an example server rack that supports one or more servers, in accordance with some embodiments.

FIG. 2 is a block diagram of an example system module in a typical computer device, which may be applied as a server in FIG. 1, in accordance with some embodiments.

FIG. 3A is a block diagram of an example PSU driven by a plurality of AC power supply signals, in accordance with some embodiments.

FIG. 3B is a block diagram of another example PSU driven by a plurality of DC power supply signals, in accordance with some embodiments.

FIG. 3C illustrates examples schemes 340 to manage power consumption of a server 120 using a PSU 216, in accordance with some embodiments.

FIG. 4 is a block diagram of an example PSU driven by two power supply signals, in accordance with some embodiments.

FIG. 5A is a perspective view of an example PSU driven by two power supply signals, in accordance with some embodiments, and FIG. 5B is a rear view of the example PSU shown in FIG. 3A, in accordance with some embodiments.

FIGS. 6A, 6B, and 6C are block diagrams of example PSUs each of which is driven by two respective AC power supply signals having distinct phases, in accordance with some embodiments.

FIG. 7A is a schematic diagram of an example PSU for generating two DC power supplies (e.g., +54 V and +12 V), in accordance with some embodiments.

FIG. 7B is schematic diagrams of an example DC-to-DC converter portions applied in a power converter of a PSU, in accordance with some embodiments.

FIGS. 8A and 8B are flow diagrams of two example processes of generating a target DC power supply based on a plurality of power supply signals by a PSU, in accordance with some embodiments.

FIG. 9 is a block diagram of a server system including a server driven by a plurality of PSUs, in accordance with some embodiments.

FIG. 10A is a schematic diagram of an example power interface used in a PSU shown in FIG. 9, in accordance with some embodiments.

FIG. 10B is a schematic diagram of an example AC-DC converter 902 used in a PSU shown in FIG. 9, in accordance with some embodiments.

FIG. 11 is a schematic diagram of an example power converter of a PSU, in accordance with some embodiments.

Like reference numerals refer to corresponding parts throughout the several views of the drawings.

### DETAILED DESCRIPTION

Reference will now be made in detail to specific embodiments, examples of which are illustrated in the accompanying drawings. In the following detailed description, numerous non-limiting specific details are set forth in order to assist in understanding the subject matter presented herein. But it will be apparent to one of ordinary skill in the art that various alternatives may be used without departing from the scope of claims and the subject matter may be practiced without these specific details.

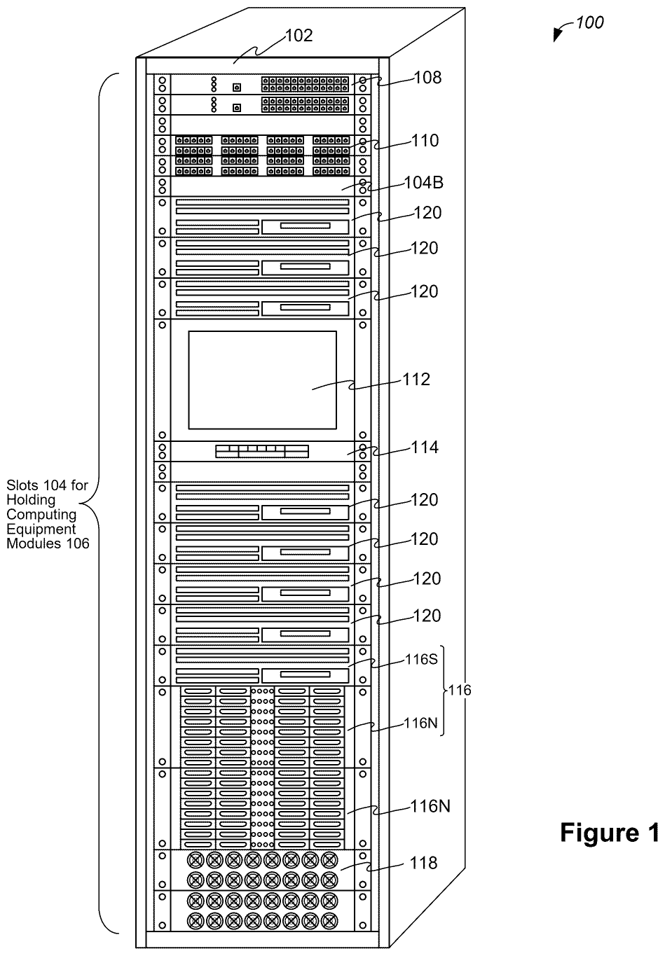

FIG. 1 is a front view of an example server rack 100 (also known as a rack mount, a rack cabinet, or simply a rack) that supports one or more servers 120, in accordance with some embodiments. The server rack 100 includes a frame 102 and a plurality of slots 104, and may be used in a data center, a server room, or a network closet for supporting, organizing, and managing a plurality of computing equipment modules 106 (e.g., servers 120, storage devices 116S and 116N, networking equipment, and other types of hardware). Each of the plurality of slots 104 of the server rack 100 is configured to receive and support a respective computing equipment module 106. In some embodiments, the plurality of slots 104 include at least one blank slot 104B that is not used to provide mechanical support to any equipment module 106 and can receive an equipment module 106 if needed. In some implementations, the server rack 100 has a predefined width of 19 or 23 inches, a height up to 84 inches or more, and a depth selected from 24, 32, 40, or 48 inches.

Examples of the computing equipment modules 106 supported by the plurality of slots 104 of the server rack 100 include, but are not limited to, a firewall module 108, a switch box 110, a server 120, a display device 112, a keyboard 114, a solid-state drive (SSD) 116S, a network-attached storage 116N, and an uninterruptible power supply (UPS) 118. Each computing equipment module 106 plays a respective role in maintaining a network and computing environment. In some embodiments, a firewall module 108 is a network security device that monitors and controls incoming and outgoing network traffic based on predetermined security rules, thereby establishing a barrier between a trusted internal network and untrusted external networks. The firewall module 108 may be placed near a network ingress point to protect the server rack 100 from unauthorized access, malware, and cyberattacks. In some embodiments, the firewall module 108 includes packet filtering, stateful inspection, VPN support, and intrusion prevention systems (IPS). In some embodiments, a switch box 110 is placed near the network ingress point jointly with the firewall module 108, and configured to receive incoming signals and forward the incoming signals (e.g., which may be converted to electrical signals) to different servers 120 mounted on the server rack 100. The switch box 110 is applied in the server rack 100 to minimize cable length and ensure efficient network traffic management. The switch box 110 may support different speeds (e.g., 800 gigabits per second (Gbps), 1.6 Tbs, 3.2 Tbs), have multiple ports (24, 48, etc.), and offer features like virtual local area network (VLAN) support, PoE (Power over Ethernet), and managed or unmanaged capabilities.

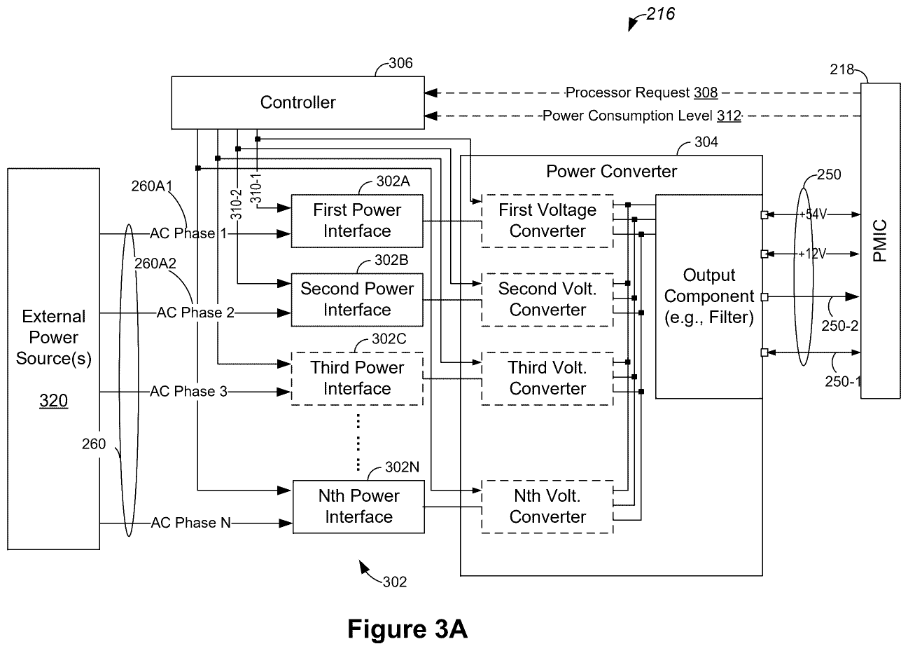

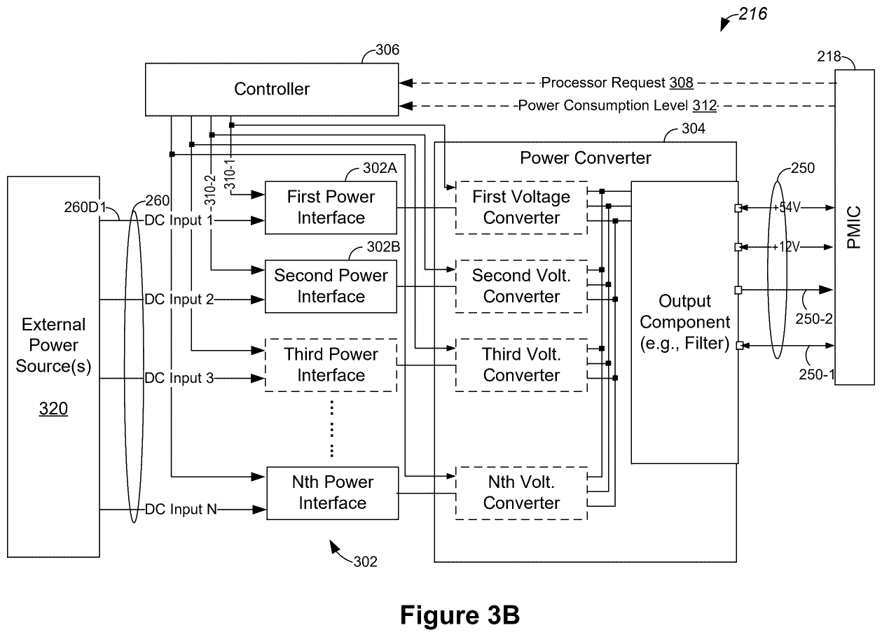

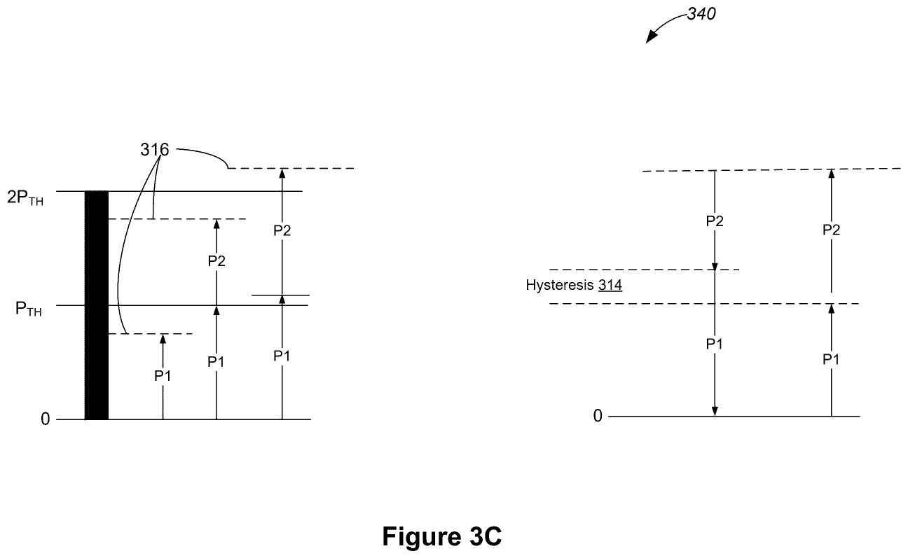

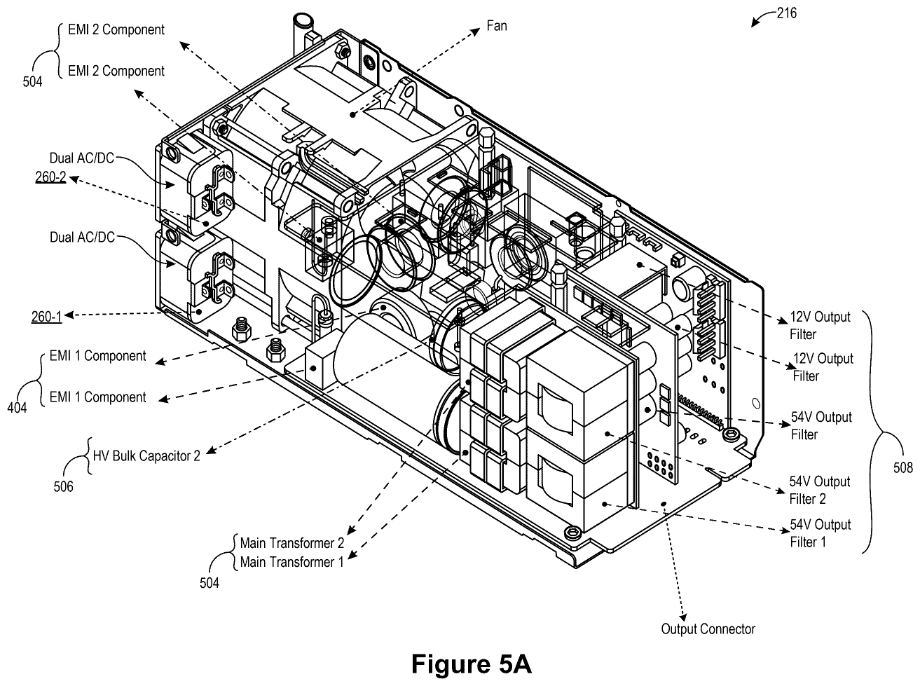

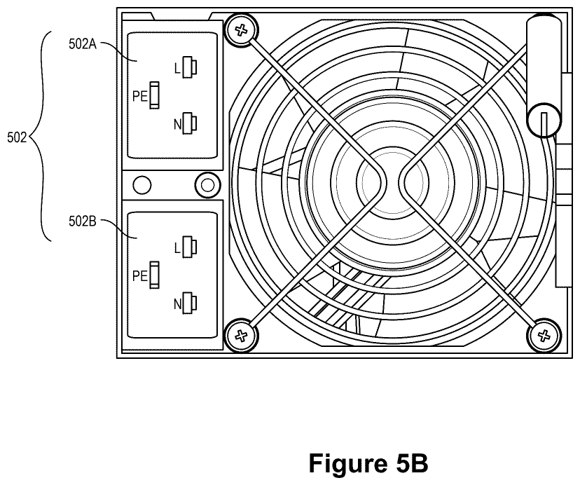

The plurality of computing equipment modules 106 of the server rack 100 may include a plurality of servers 120 each of which is configured to provides data, resources, services, or programs to other client devices over one or more wired or wireless communication networks. Each server 120 is mounted in a slot 104 of the server rack 100 and configured to provide one or more services (e.g., web hosting, database management, and application support). The servers 120, mounted on the server rack 100, may provide higher processing power, large memory capacity, redundant power supplies, and hot-swappable components for high availability and reliability compared with individual client devices. In some embodiments, the one or more rack servers 120 include a plurality of graphics processing units (GPU) configured to implement machine learning operations, e.g., in a data center associated with machine learning tasks. In some embodiments, the server 120 includes one or more processors, memory storing one or more programs for execution by the one or more processors, and a system housing for enclosing the one or more processors, the memory, and a power supply component (e.g., a PSU 216 in FIGS. 3A, 3B, and 5).

The SSD 116S and the network-attached storage 116N are configured to provide storage space for the servers 120 installed in the server rack 100. The SSD uses flash memory to store data and shows high speed, low latency, durability, and lower power consumption, and diverse capacities and form factors compared to hard drive devices (HDDs). Conversely, the network-attached storage (NAS) 116N is a dedicated file storage device that provides data access to a network and allows a large number of different types of client devices to retrieve data from centralized disk capacity. In some embodiments, the network-attached storage 116N may have a high capacity, redundant array of independent disks (RAID), support for a plurality of file-sharing protocols (NFS, SMB/CIFS, FTP), user management, and backup features. In some embodiments, the SSDs 116S are storage drives for speed, and for example, used within the servers 120 disposed on the same server rack 100, while the NAS 116N is configured for file sharing, data backup, and remote access.

In some implementations, the UPS 118 is applied to provide emergency power to other computing equipment modules 106 in case of a power outage, allowing them to remain operational long enough to safely shut down or switch to an alternative power source. In an example, the UPS 118 is mounted in the server rack 100 or placed on a bottom slot to support the weight, providing backup power to other computing equipment modules 106. The UPS 118 provides one or more of battery backup, surge protection, voltage regulation, real-time monitoring, management software, and/or varying runtimes based on capacity and load.

The server rack 100 further includes a plurality of mechanical structures configured to provide mechanical support, or facilitate access, to the plurality of computing equipment modules 106. The plurality of mechanical structures include one or more of: an open frame rack (e.g., having no door or side panel), mounting rails, cable management features (e.g., arms, hooks, and trays), power strips, shelves, drawers, and blanking panels. In some embodiments, the plurality of mechanical structures also includes a rack enclosure (e.g. cabinet), lockable doors, and side panels to protect the computing equipment modules 106 from unauthorized access. In an example, the server rack 100 includes, or is coupled to, a plurality of panels configured to convert the server rack 100 to a server cabinet. In some embodiments, the server rack 100 further includes a cooling system or a ventilation system to facilitate heat dissipation. Using a server rack 100 helps optimize space, improve cooling efficiency, simplify maintenance, and enhance the overall organization and management of information technology (IT) infrastructure.

Various embodiments of this application are directed to methods, apparatuses, structures, devices, and systems for providing power to a server system (e.g., including a server 120). In accordance with at least some embodiments disclosed herein is the realization that some existing power supplies have only a single AC input, has an input current limit, and cannot provide high power above a threshold power level. In some embodiments of this application, the server system utilizes a single PSU, and the PSU is configured to receive a plurality of AC or DC power inputs and provide a plurality of output voltages to satisfy a power demand of the server 120 in an efficient and reliable manner. For example, the PSU receives a plurality of single-phase AC inputs and operates with redundancy and current sharing to provide power to a server 120 that is applied in a data center to implement machine learning tasks. In some embodiments, a plurality of single-phase AC power supply signals (e.g., having two or three phases) are applied to power the server with a target power level up to 6 KW. Further, in some embodiments, a plurality of DC power supplies are generated by the PSU to power processing functions in different electronic components in the server system. Alternatively, in some embodiments, a plurality of PSUs are coupled in parallel, and each PSU is driven by a plurality of power supply signals (e.g., DC signals, AC signals having the same phase, AC signals having two or three phases) and generates one or more DC power supplies to drive processing functions of the server system.

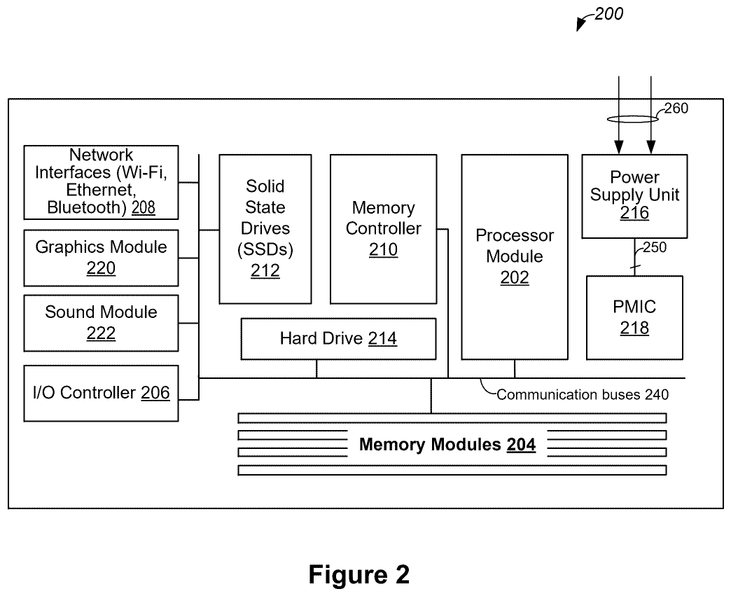

FIG. 2 is a block diagram of an example system module 200 in a typical computer device, which may be applied as a server 120 in FIG. 1, in accordance with some embodiments. The system module 200 in this computer device includes at least a processor module 202, memory modules 204 for storing programs, instructions and data, an input/output (I/O) controller 206, one or more communication interfaces such as network interfaces 208, and one or more communication buses 240 for interconnecting these components. In some embodiments, the I/O controller 206 allows the processor module 202 to communicate with an I/O device (e.g., a keyboard, a mouse or a track-pad) via a universal serial bus interface. In some embodiments, the network interfaces 208 includes one or more interfaces for Wi-Fi, Ethernet and Bluetooth networks, each allowing the computer device to exchange data with an external source, e.g., a server or another computer device. In some embodiments, the communication buses 240 include circuitry (sometimes called a chipset) that interconnects and controls communications among various system components included in system module 200.

In some embodiments, the memory modules 204 include high-speed random-access memory, such as DRAM, static random-access memory (SRAM), double data rate (DDR) dynamic random-access memory (RAM), or other random-access solid state memory devices. In some embodiments, the memory modules 204 include non-volatile memory, such as one or more magnetic disk storage devices, optical disk storage devices, flash memory devices, or other non-volatile solid state storage devices. In some embodiments, the memory modules 204, or alternatively the non-volatile memory device(s) within the memory modules 204, include a non-transitory computer readable storage medium. In some embodiments, memory slots are reserved on the system module 200 for receiving the memory modules 204. Once inserted into the memory slots, the memory modules 204 are integrated into the system module 200.

In some embodiments, the system module 200 further includes one or more components selected from a memory controller 210, solid state drives (SSDs) 212, a hard disk drive (HDD) 214, a power supply unit (PSU) 216, power management integrated circuit (PMIC) 218, a graphics module 220, and a sound module 222. The memory controller 210 is configured to control communication between the processor module 202 and memory components, including the memory modules 204, in the computer device. The SSDs 212 are configured to apply integrated circuit assemblies to store data in the computer device, and in many embodiments, are based on NAND or NOR memory configurations. The HDD 214 is a conventional data storage device used for storing and retrieving digital information based on electromechanical magnetic disks. The PSU 216 is configured to receive a plurality of power supply signals 260 and provide a plurality of DC power supplies 250 (e.g., 12V, 54V). The PMIC 218 is configured to modulate the plurality of DC power supplies 250 to other desired DC voltage levels, e.g., 5V, 3.3V or 1.8V, as required by various components or circuits (e.g., the processor module 202) within the computer device. The graphics module 220 is configured to generate a feed of output images to one or more display devices according to their desirable image/video formats. The sound module 222 is configured to facilitate the input and output of audio signals to and from the computer device under control of computer programs.

It is noted that communication buses 240 also interconnect and control communications among various system components including components 210-222.

FIG. 3A is a block diagram of an example PSU 216 driven by a plurality of AC power supply signals 260A, in accordance with some embodiments. FIG. 3B is a block diagram of another example PSU 216 driven by a plurality of DC power supply signals 260D, in accordance with some embodiments. The PSU 216 includes a plurality of power interfaces 302, a power converter 304, and a controller 306. The plurality of power interfaces 302 are configured to receive a plurality of power supply signals 260, e.g., from one or more power sources 320 (e.g., utility power grid, UPS 118, backup generator). For example, the plurality of power interfaces 302 include a first power interface 302A, a second power interface 302B,. and an N-th power interface 302N, where N is a positive integer greater than 1. The power converter 304 is coupled to the plurality of power interfaces 302, and is configured to generate a plurality of DC power supplies 250 based on at least one of the plurality of power supply signals 260. The controller 306 is configured to control the plurality power interfaces 302 (e.g., independently of one another) and select the at least one of the plurality of power supply signals 260 to generate the plurality of DC power supplies 250.

More specifically, in some embodiments, the controller 306 is coupled to at least the first power interface 302A and the second power interface 302B, and is configured to select at least one of the first power supply signal and the second power supply signal via the first power interface 302A and the second power interface 302B (e.g., independently of each other) to be input into the power convert 306 for generating the plurality of DC power supplies 250. In some embodiments, the controller 306 is coupled to the power converter 304 in addition to the first power interface 302A and the second power interface 302B. The controller 306 select at least one of the first power supply signal and the second power supply signal via the first power interface 302A and the second power interface 302B, as well as by enabling at least one of a plurality of voltage converters of the power converter 304. Each selected voltage converter is enabled jointly with a respective power interface 302.

In some embodiments, the PSU 216 is coupled to, or included in, an artificial intelligence (AI) server 120 configured to implement data inferencing tasks for one or more AI-based applications. Machine learning models may be trained on the AI server 120, a GPU-enabled server and server cluster, or a GPU-enabled cloud instance. Further, in some embodiments, the PSU 216 is coupled to a PMIC 218 of the AI server 120, and the PMIC 218 is configured to modulate the plurality of DC power supplies 250 to other desired DC voltage levels (e.g., +3V, +1.8V) as required by various components or circuits (e.g., the processor module 202) within the AI server 120.

Referring to FIG. 3A, in some embodiments, the plurality of power supply signals 260 include a plurality of AC power supply signals 260A. Each AC power supply signal 260A includes a respective single-phase AC input signal. The PSU 216 receives the plurality of AC power supply signals (e.g., 260A1, 260A2) and generates a plurality of DC power supplies 250. The plurality of AC power supply signals 260A provide redundancy and current sharing. Stated another way, in some embodiments, the example PSU 216 acts as a power supply with multi single-phase AC input signals, thereby providing multi DC output voltages with redundancy and current sharing (e.g., to support operation of the AI server 120).

Referring to FIG. 3B, in some embodiments, the plurality of power supply signals 260 include a plurality of DC input supply signals (e.g., 260D1). In some embodiments, a first DC input supply signal 260D1 is greater than the a first DC power supply 250-1, and the power converter 304 includes a bucket converter configured to convert the first DC input supply signal 260D1 to the first DC power supply 250-1. Conversely, in some embodiments, the first DC input supply signal 260D1 is lower than the first DC power supply 250-1, and the power converter 304 includes a boost converter configured to convert the first DC input supply signal 260D1 to the first DC power supply 250-1.

In some embodiments, the plurality of DC power supplies 250 are used in a rack system 100 as server power supplies (also called server power rails). Example server power supplies include, but are not limited to +54V, +12V, and +12 VSB. The plurality of DC power supplies 250 serve distinct purposes to ensure efficient and reliable operation of the server 120. For example, the +54V rail is used for high-power components and efficient power distribution, reducing current to minimize power losses, and may be used in telecommunication and data center equipment for long-distance power delivery. In some situations, the +12V rail is a standard voltage used to power a variety of server components, including CPUs, GPUs, hard drives, and cooling fans, providing a consistent and reliable power source for these electrical and mechanical parts in the server 120. In some situations, the +12 VSB rail is a standby power rail supplying power when main server power (e.g., the +12V rail) is off, ensuring that essential management functions (e.g., remote management controllers, system monitoring, and wake-on-LAN features) remain operational. The +12 VSB rail is always on when the PSU 216 is connected to an external power source 320 (e.g., the mains), enabling continuous management and monitoring capabilities of the server 120.

In some embodiments, the plurality of DC power supplies includes one or more of: a first DC power supply 250-1 and a second DC power supply 250-2. The first DC power supply 250-1 is enabled in response to detection of an incoming processor request 308. The second DC power supply 250-2 is enabled, independently of whether an incoming processor request 308 is received for the second DC power supply 250-2. An example of the second DC power supply 250-2 is the +12 VSB.

FIG. 3C illustrates examples schemes 340 to manage power consumption of a server 120 using a PSU 216, in accordance with some embodiments. In some embodiments, the controller 306 of the PSU 216 is configured to select the at least one of the first power supply signal 260D1 and the second power supply signal 260D2. The controller 306 generates a first input control signal 310-1 for selecting the first power supply signal 260D1 and a second input control signal 310-2 for selecting the second power supply signal 260D2. Two external power sources 320 connected to the first and second power interfaces 302A and 302B can be controlled adaptively based on a power demand of a server 120 driven by the PSU 216, e.g., when the server 120 is used to implement artificial intelligence tasks requiring a high power consumption level.

In some embodiments, the first input control signal 310-1 controls (e.g., enables or disables) the first power interface 302A, a first voltage converter of the power converter 304, or both of them for selecting the first power supply signal 260D1. The second input control signal 310-2 controls (e.g., enables or disables) the second power interface 302B, a second voltage converter of the power converter 304, or both of them for selecting the second power supply signal 260D2.

In some embodiments, in accordance with a determination that a power consumption level 316 is lower than a first power threshold P_{TH}, the controller 306 disables the second power interface 302B, and enables the first power interface 302A. Further, in some embodiments, in accordance with a determination that the power consumption level 316 reaches and goes beyond the first power threshold P_{TH}, the controller 306 may enable both the second power interface 302B and the first power interface 302A. In an example, the power interfaces 302A and 302B contribute equal power to the power consumption level 316. In another example, the power interface 302A provides a power level equal to the first power threshold P_{TH}, while the power interface 302B provides a remainder of the power consumption level 316.

In some situations, when the power consumption level 316 goes beyond a second power threshold (e.g., 2P_{TH}), additional power interface (e.g., 302C, 302N) may be enabled. Alternatively, the power interfaces 302A and 302B may be controlled to provide the power consumption level 316 jointly and contribute equal power.

In an example, total power consumption of an AI server 120 is 12 KW and can be used with two external power sources 320 each having a rated power of 6 KW. When the AI server operates at 6 KW or below, the external power sources 320 coupled to the two power interface 302 may be enabled to perform current sharing, allowing each external power source 320 to provide a power of 3 KW via the PSU 216 to achieve a target efficiency (e.g., 50%). For example, when a system load of the PSU is greater than 50%, the PSU operates in redundant mode with both of the two power interfaces 302 enabled. When the system load is less than 40%, the first power interface 302A is enabled, and the second power interface 302B is disabled. In a range of the system load (40˜50%), the PSU 216 operates in a hysteresis zone 314. More specifically, when the power consumption increases, the controller 306 enables the second power interface 302B when the system load reaches 40%; when the power consumption decreases, the controller 306 disables the second power interface 302B when the system load reaches 50%.

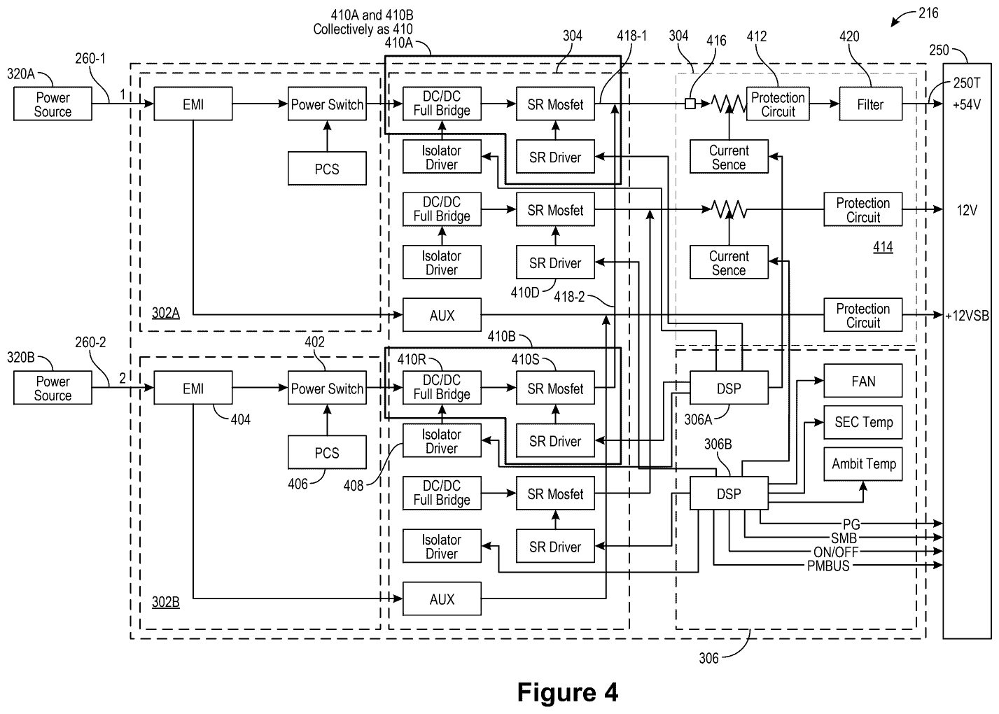

FIG. 4 is a block diagram of an example PSU 216 driven by two power supply signals 260, in accordance with some embodiments. The PSU 26 is configured to provide power to a computer system (e.g., one or more servers 120 in FIG. 1). The PSU 216 includes a plurality of power interfaces 302, a power converter 304, a controller 306. The plurality of power interfaces 302 includes a first power interface 302A configured to receive a first power supply signal 260-1 from a first power source 320A and a second power interface 302B configured to receive a second power supply signal 260-2 from a second power source 320B. The controller 306 controls the plurality of power interfaces 302 (e.g., independently of one another) and selects the at least one of the plurality of power supply signals 260 to drive the power converter 304 and generate the plurality of DC power supplies 250. In some embodiments, the controller 306 includes one or more digital signal processors DSPs (e.g., DSPs 306A and 306B) for controlling generations of the plurality of DC power supplies 250.

In some embodiments, each of the power interfaces 302 (e.g., power interface 302A or 302B) includes one or more of: a power switch 402, an electromagnetic interference (EMI) component 404, a fuse, a circuit breaker, an inrush limiter, and a passive filter. The power switch 402 is coupled to the controller 306, and is configured to receive a respective power control signal 406 (e.g., provided by the controller 306) and connect the respective power interface 302A or 302B to provide the first power supply signal 260-1 or the second power supply signal 260-2 to the power converter 304. For example, the power switch 402 include a totem-pole power factor correction (PFC) circuit that uses alternating high and low-side switches to improve a power factor and reduce harmonics in AC to DC conversion. The EMI component 404 is configured to control an EMI level in a power supply signal 260 (e.g., signal 206A or 206B). The inrush limiter is configured to limit an inrush current of the power supply signal 260 (e.g., signal 260-1 or 206-2) to avoid gradual damage to the PSU 216 and avoid blowing the fuse or tripping a circuit breaker. The passive filter is configured to control a noise level of the respective power supply signal 260 (e.g., signal 206-1 or 206-2).

In some embodiments, for each power source 320A or 320B, the power converter 304 includes an isolation driver 408, a conversion circuit 410 (e.g., including portion 410B), and a reverse voltage protection circuit 412. The isolation driver 408 is configured to provide electrical isolation between the control signal 406 and the conversion circuit 410. Examples of the isolation driver 408 include, but are not limited to, transformers, optocouplers, or capacitive coupling. The conversion circuit 410 is configured to convert the power supply signal 260 to a DC power supply 250. In some embodiments, the conversion circuit 410 includes a bridge converter 410R, a synchronization rectification transistor 410S, and a synchronization rectification driver 410D. After the bridge converter 410R converts the power supply signal 260 provided by the power interface 302, the transistor 410S actively switches on and off in synchronization with a control waveform provided by the driver 410D, allowing a current to flow during active periods. The reverse voltage protection circuit 412 prevents damage to electronic components that can occur if an output associated with the DC power supply 250 is connected incorrectly, e.g., with a higher power source. For example, the reverse voltage protection circuit 412 includes an Oring MOSFET, which is coupled as a diode for blocking current conduction, e.g., in case of a reverse current detection.

In some embodiments, the plurality of DC power supplies 250 includes a target DC power supply 250T (e.g., +54 V). The power converter 304 further includes an output component 414 configured to receive, at a filter input 416, both a first target supply 418-1 generated based on the first power supply signal 260-1 and a second target supply 418-2 generated based on the second power supply signal 260-2 and generate the target DC power supply 250T. In some embodiments, the output component 414 includes a filter 420 configured to filter the target DC power supply 250T, e.g., reducing noise in a frequency range. In some embodiments, the power converter 304 further includes two voltage converter portions (e.g., conversion circuit portions 410A and 410B) coupled to the first power interface 302A and the second power interface 302B, respectively. The two voltage converter portions are configured to generate the first target supply 418-1 and the second target supply 418-2, respectively. The first target supply 418-1 and the second target supply 418-2 are coupled to each other at outputs of the two voltage converter portions (e.g., at outputs of the conversion circuit portions 410A and 410B), which correspond to and the filter input 416 of the output component 414.

In some embodiments, the first power interface 302A is enabled (e.g., by enabling its associated power switch 402), and the second power interface 302B is disabled (e.g., by disabling its associated power switch 402). The first power supply signal 260-1 is applied to drive the PSU 216, i.e., provide power consumed by the PSU 216 and electronic components to be powered by the PSU 216, while the second power supply signal 260-2 is decoupled and provides no or little power. Alternatively, in some embodiments, the first power interface 302A is disabled, and the second power interface 302B is enabled. Alternatively, in some embodiments, both the first power interface 302A and the second power interface 302B are enabled. The power consumed by the PSU 216 and electronic components to be powered by the PSU 216 is provided by the power supply signals 260-1 and 260-2 jointly, e.g., equally or based on allocations. More specifically, in some embodiments, when the first power interface 302A and the second power interface 302B are both enabled, the first power interface 302A and the second power interface 302B are controlled to provide substantially equal portions to a target power consumption level, e.g., using external power sources 320. Alternatively, in some embodiments, when the first power interface 302A and the second power interface 302B are both enabled, the first power interface 302A and the second power interface 302B are controlled to provide two respective power portions to a target power consumption level. The two respective power portions may have a fixed ratio.

FIG. 5A is a perspective view of an example PSU 216 driven by two power supply signals 260-1 and 260-2, in accordance with some embodiments, and FIG. 5B is a rear view of the example PSU 216 shown in FIG. 3A, in accordance with some embodiments. The PSU 216 includes two power interfaces 302A and 302B, a power converter 304, and a controller 306. The first power interface 302A configured to receive a first power supply signal 260-1 from a first power source and a second power interface 302B configured to receive a second power supply signal 260-2 from a second power source. The controller 306 controls the power interfaces 302A and 302B (e.g., independently of one another) and selects at least one of the power supply signals 260-1 and 260-2 to generate the plurality of DC power supplies 250. Referring to FIG. 5B, in some embodiments, each of the power supply signal 260-1 and 260-2 includes a respective AC power supply signal 260A1 or 260A2 (FIG. 3A), and a respective power interface 302A or 302B includes an AC power receptacle 502A or 502B exposed on a rear side of the PSU 216 and configured to receive the AC power supply signal 302A or 302B.

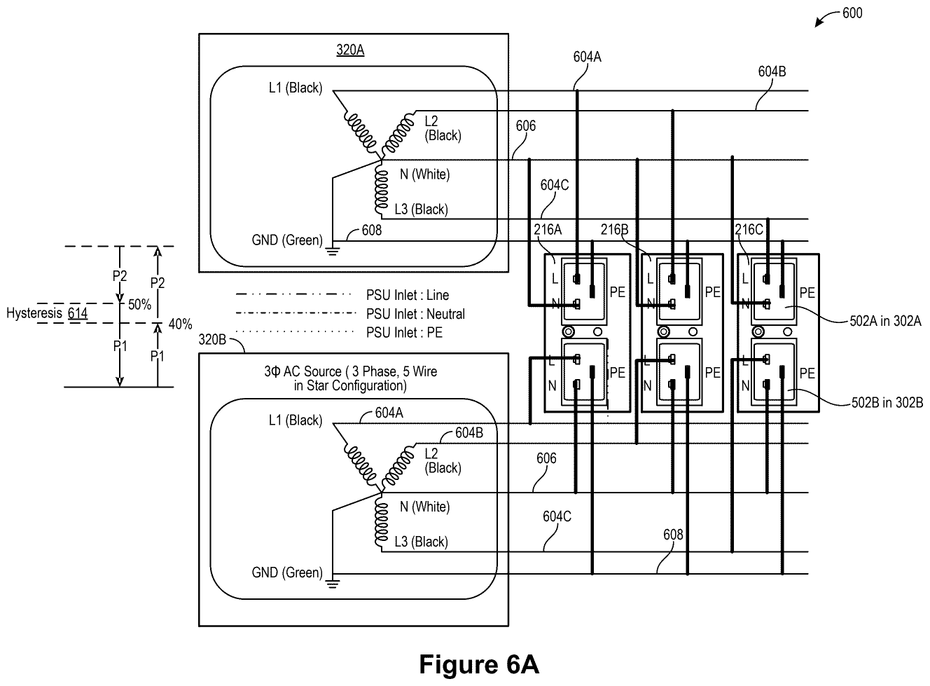

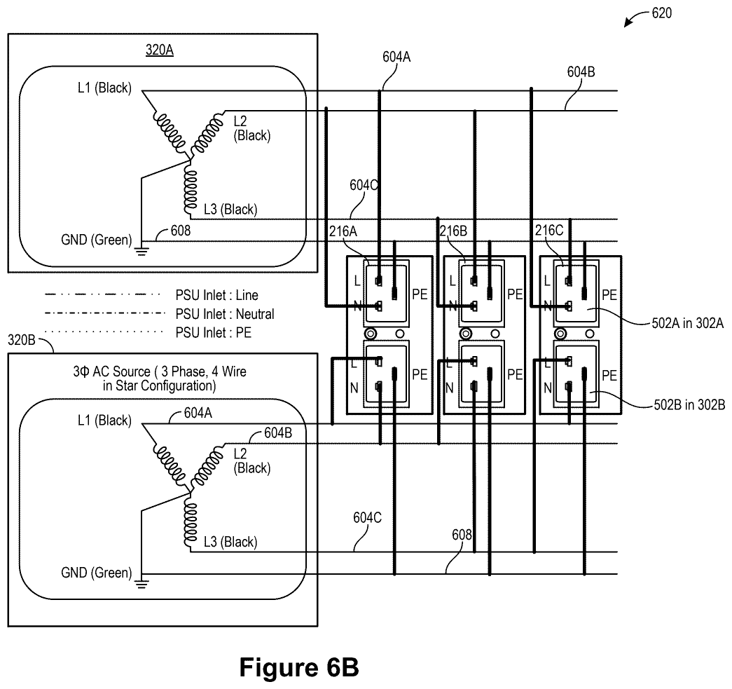

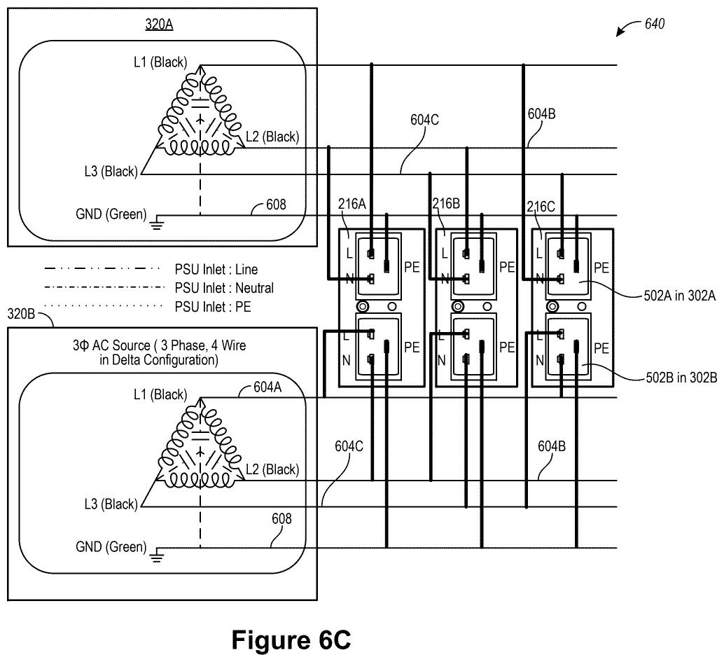

In some embodiments, the PSU 216 may include a power supply housing 510 that encloses the first power interface 302A, the second power interface 302B, the power converter 304, and the controller 306. In some embodiments, a server 120 includes a single PSU 216. In some embodiments, a server 120 includes a plurality of PSUs 216 (e.g., three PSUs 216 in FIGS. 6A-6C).

In some embodiments, the PSU 216 includes one or more components of: EMI components 404, transformers 504, high voltage bulk capacitors 506, output filters 508, output connectors 512, and a circuit board (hidden inside the PSU 216). These components are electrically coupled to form the two power interfaces 302A and 302B, the power converter 304, and the controller 306 of the PSU 216, thereby being configured to generate a plurality of DC power supplies 250 based on the two power supply signals 260-1 and 260-2. The PSU 216 is configured to output the two DC power supplies via the output connectors 512. For examples, the output connectors 512 output two DC power supplies 250 corresponding to +54 V and +12V with reference to a ground.

Referring to FIG. 5B, in some embodiments, a power receptacle 502A or 502B includes a line node L, a neutral node N, and a protection earth node PE (also called a ground node). The line node L carries a current from an external power source 320 to the PSU 216, e.g., at a voltage of 120V or 240V depending on a geographical region. The neutral node N carries the current back to the external power source 320 (FIG. 3A), ideally at or near 0V, providing a return path for the current. The protection earth node PE is a safety feature that offers a path for electrical current to return to the ground in case of a fault, preventing electric shock and equipment damage. The protection earth node PE carries no voltage (0V) unless there is a fault. These three nodes (L, N, and PE) ensure safe power delivery to the PSU 216.

FIGS. 6A, 6B, and 6C are block diagrams of example PSUs 216A, 216B, and 216C each of which is driven by two respective AC power supply signals 260 having distinct phases, in accordance with some embodiments. A server 120 (e.g., an AI server) is disposed in one of a plurality of slots 104 of a server rack 100 (FIG. 1), and includes three PSUs 216A, 216B, and 216C disposed inside the server 120. In some embodiments, each PSU 216 is configured to receive two respective AC power supply signals 260 from an external power source 320 (FIG. 3A) including a three phase power supply, via a power receptacle 502. The three phase power supply includes three phases that are 120 degrees out of phase with each other. In some embodiments, a first power supply signal 260A1 corresponds to an alternating current signal having a first phase, and a second power supply signal 260A2 corresponds to an alternating current signal having a second phase that is offset from the first phase by one-third of a power signal cycle (e.g., by 120 degrees). A power receptacle 502 corresponding to a star scheme has three nodes (L, N, and PE), and a power receptacle 502 corresponding to a delta scheme has two nodes (L and PE).

Referring to FIGS. 6A and 6B, in some embodiments, he PSUs 216A, 216B, and 216C are coupled to two respective power sources 320A and 320B each providing an AC power supply and having a star scheme. For each power source 320A or 320B, the AC power supply includes five wires corresponding to three line wires 604A, 604B, and 604C having three distinct phases, a neutral wire 606, and a protection earth wire 608 (also called ground wire). The neutral nodes N of the power interfaces 302A and 302B of the PSUs receive the neutral wire 606 provided by the two external power source 320A and 320B, respectively. The protection earth nodes PE of the power interfaces 302A and 302B of the PSUs receive the protection earth wire 608 provided by the two external power source 320A and 320B, respectively. The line nodes L of the first power interface 302A of the PSUs 216A, 216B, and 216C receives three distinct line wires 604A, 604B, and 604C having three distinct phases provided by a first external power source 320A, respectively. The line nodes L of the second power interface 302B of the PSUs 216A, 216B, and 216C receives three distinct line wires 604A, 604B, and 604C having three distinct phases provided by a second external power source 320B, respectively. In some embodiments, for each PSU 216 (e.g., 216A), the line nodes L of the two power interfaces 302A and 302B correspond to the same phase (e.g., associated with the line wire 604A) of the two power sources 320A and 320B.

Referring to FIG. 6B, in some embodiments, two power sources 320A and 320B are coupled to the PSUs 216A, 216B, and 216C and have a star scheme shorting a neutral wire 606 and a protection earth wire 608 internally. Referring to FIG. 6C, in some embodiments, two power sources 320A and 320B are coupled to the PSUs 216A, 216B, and 216C and have a delta scheme skipping a neutral wire 606. In both FIGS. 6B and 6C, for each power source 320A or 320B, the AC power supply includes four wires corresponding to three line wires 604A, 604B, and 604C of three distinct phases and a protection earth wire 608.

Referring to FIGS. 6B and 6C, the protection earth nodes PE of the power interfaces 302A and 302B of the PSUs receive the protection earth wire 608 provided by the two external power source 320A and 320B, respectively. The line nodes L of the first power interface 302A of the PSUs 216A, 216B, and 216C receives three distinct line wires 604A, 604B, and 604C having three distinct phases provided by a first external power source 320A, respectively. The line nodes L of the second power interface 302B of the PSUs 216A, 216B, and 216C receives three distinct line wires 604A, 604B, and 604C having three distinct phases provided by a second external power source 320B, respectively. In some embodiments, for each PSU 216 (e.g., 216A), the line nodes L of the two power interfaces 302 correspond to the same phase (e.g., associated with the line wire 604A) of the two power sources 320A and 320B.

In some embodiments, for each of the six power interfaces 302 of the PSUs 216 (e.g., AC power receptacle 502A of PSU 216A), a respective neutral node N receives a respective one (e.g. e.g., 604B) of the three distinct line wires 604A, 604B, and 604C provided by a respective external power source 320A, and has a fixed phase shift (e.g., +120 degrees) with respect to a respective line node L of the respective power interface 302.

In other words, in some embodiments, for each PSU 216, the first power supply signal 260-1 received by the first power interface 302A corresponds to an alternating current signal having a first phase, and the second power supply signal 260-2 received by the second power interface 302B corresponds to an alternating current signal having a second phase that is synchronized with the first phase. In some embodiments, a plurality of PSUs 216 (e.g., PSUs 216A, 216B, and 216C) are applied and have phases distributed substantially evenly among three thirds of a power signal cycle.

Alternatively, in some embodiments (not shown), the first power interface 302A and the second power interface 302B of each PSU 216 correspond to two distinct phases, e.g., thereby having a phase shift of +120 or −120 degrees. Additionally, in some embodiments not shown, each PSU 216 further includes one or more power interfaces (e.g., interface 302C and/or 302N in FIG. 3A) each of which is configured to receive a respective and distinct power supply signal 260. The first power interface 302A, the second power interface 302B, and the one or more power interfaces are distributed substantially evenly among three thirds of a power signal cycle.

In some embodiments, the PSUs 216A, 216B, and 216C are powered on successively based on a total power consumption of a server 120 (e.g., corresponding to a system load of the PSUs 216A-216C). In accordance with a determination that a power consumption level is lower than a first power threshold P_{TH}, the PSUs 216B and 216C are disabled, and the PSU 216A is enabled. Further, in some embodiments, in accordance with a determination that the power consumption level reaches and goes beyond the first power threshold P_{TH}, the PSUs 216A and 216B are enabled, and the PSU 216C is disabled. Additionally, in some embodiments, in accordance with a determination that a power consumption level reaches and goes beyond a second power threshold (e.g., 2P_{TH}), the PSUs 216A, 216B, and 216C are all enabled. In an example, the PSUs 216A-216C, if enabled, provide equal power. In another example, the PSU 216A provides a power level up to the first power threshold P_{TH}, and the PSU 216B (if enabled) provides a power level in excess of the first power threshold P_{TH}, while the PSU 216C (if enabled) provides a power level in excess of the second power threshold.

In some embodiments, when a system load of the PSUs 216A-216C is greater than 50%, the PSUs 216A and 216B operate in a redundant mode with two PSUs 216A and 216B enabled. When the system load is less than 40%, the PSU 216A is enabled, and the PSU 216B is disabled (e.g., enters a sleep mode). In a range of the system load (40˜50%), the PSU 216B operates in a hysteresis zone 614. More specifically, when the power consumption increases, the PSU 216B is enabled when the system load reaches 40%; when the power consumption decreases, the PSU 216B is disabled when the system load reaches 50%.

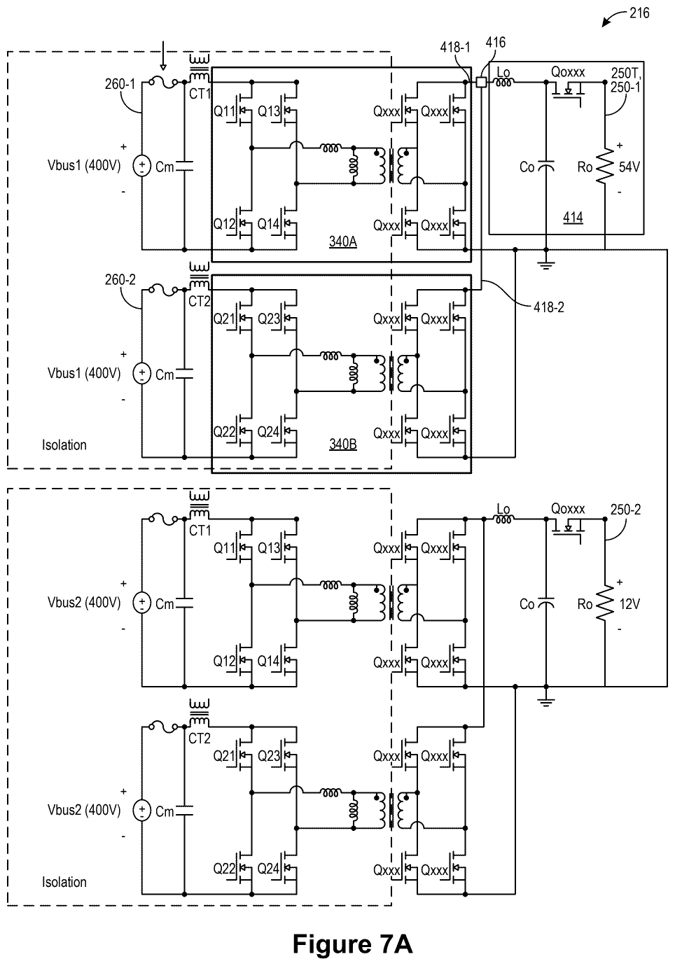

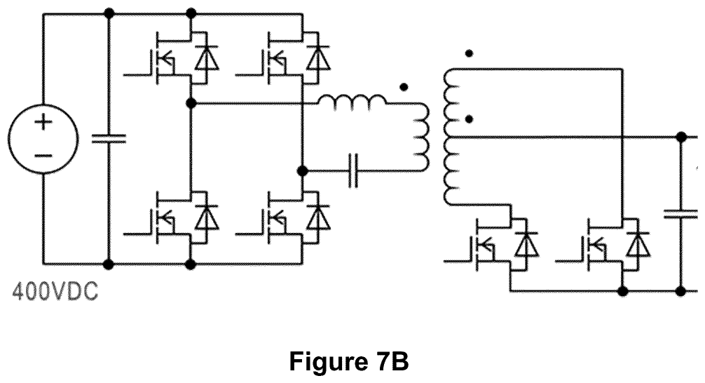

FIG. 7A is a schematic diagram of an example PSU for generating two DC power supplies 250 (e.g., +54 V and +12 V), in accordance with some embodiments, and FIG. 7B is schematic diagrams of an example DC-to-DC converter portions applied in a power converter 304 of a PSU 216, in accordance with some embodiments.

Referring to FIG. 7A, in some embodiments, the two power supplies 250 includes a target DC power supply 250T (e.g., +54 V). The power converter 304 further includes an output component 414 configured to receive, at a filter input 416, both a first target supply 418-1 generated based on a first power supply signal 260D1 and a second target supply 418-2 generated based on a second power supply signal 260D2 and generate the target DC power supply 250T. In some embodiments, the power converter 304 further includes two voltage converter portions 304A and 304B coupled to the first power interface 302A and the second power interface 302B, respectively. The two voltage converter portions 304A and 304B are configured to generate the first target supply 418-1 and the second target supply 418-2, respectively. The first target supply 418-1 and the second target supply 418-2 are coupled to each other at outputs of the two voltage converter portions 304A and 304B, which correspond to and the filter input 416 of the output component 414.

In some embodiments, each of the power supply signals 260D1 and 260D-2 includes a respective DC input supply signal. For example (FIG. 7B), each power supply signal 260D1 or 260D2 is +400 V DC signal, which is higher than the target DC power supply 250-1 of +54V. Each of the two voltage converter portions 304A and 304B includes a respective buck converter to generate the first or second target supply 418-1 or 418-2 based on the power supply signals 260D1 and 260D2. In an example, each power supply signal 260D1 or 260D2 is +30V, which is the target DC power supply 250-1 of +54V. Each of the two voltage converter portions 304A and 304B includes a respective boost converter to generate the first or second target supply 418-1 or 418-2 based on the power supply signals 260D1 and 260D2.

In some embodiments, the plurality of DC power supplies 250 include a first DC power supply 250-1 (e.g., +54V) and a second DC power supply 250-2 (e.g., +12V) lower than the first DC power supply. Referring to FIG. 7A, the second DC power supply 250-2 may be generated from the AC power supply signals 260 (e.g., 400 DC voltage). Alternatively, the second DC power supply 250-2 may be generated from the first DC power supply 250-1, e.g., by a buck converter.

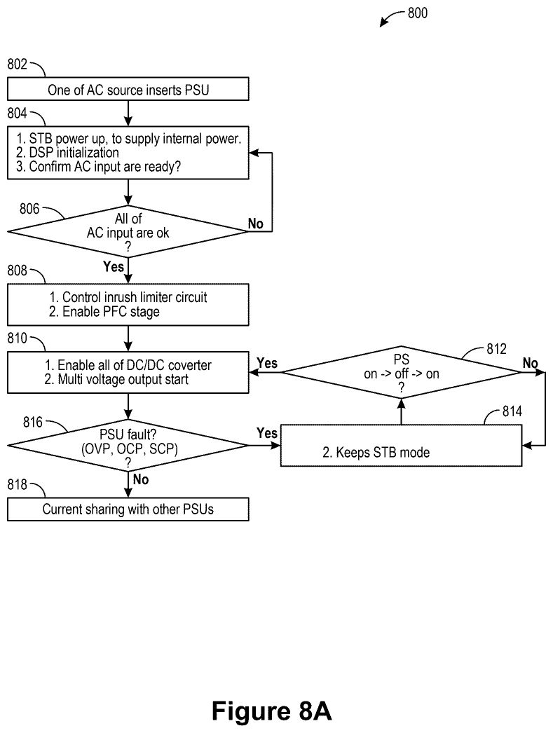

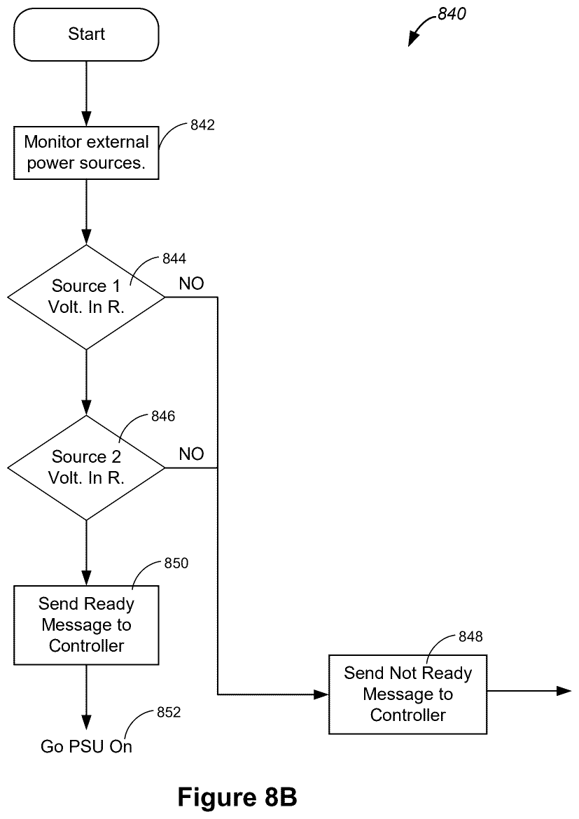

FIGS. 8A and 8B are flow diagrams of two example processes 800 and 840 of generating a target DC power supply 250 based on a plurality of power supply signals 260 by a PSU 216, in accordance with some embodiments. Referring to FIG. 8A, in some embodiments, one or more external power sources 320 are connected (operation 802) to a PSU 216. A warmup procedure 804 includes enabling an active mode for terminating a standby (STB) mode and providing internal power, initializing DSPs of a controller 306, and confirming that power supply signals 260 are ready. The warm up procedure 804 is implemented until it is confirmed (operation 806) that the power supply signals 260 are ready. After the power supply signals 260 are ready, the power interfaces 302A and 302B are set up (operation 808). For example, an inrush limiter circuit and a PFC circuit of a power switch 402 are initiated. The power converter 304 is enabled (operation 810) to output the DC power supplies 250. The controller 306 monitors whether a user action 812 is received to turn off the PSU 216. In response to detection of the user action 812 to turn off the PSU 216 or a fault 816 with the PSU 216, the controller 306 disables (operation 814) the PSU 216 from outputting the DC power supplies 250 and controls the PSU 216 to operate in the STB mode. When the PSU 216 operates without the fault 816, the PSU 216 may operate jointly with additional PSUs 216 to provide power to the server 120 jointly.

Referring to FIG. 8B, in some embodiments, when two external power sources 320 are connected to a PSU 216, the external power sources 320 are monitored (operation 842). When outputs of both of the power sources 320A and 320B are not (operations 844 and 846) in a target voltage range, a message is sent (operation 848) to the controller 306 indicating the power sources 320A and 320B are not ready. When outputs of both of the power sources 320A and 320B are controlled (operations 844 and 846) in the target voltage range, a message is sent (operation 850) to the controller 306 indicating the power sources 320A and 320B are ready, and the PSU 216 continues to get started and generate (operation 852) the DC power supplies 250.

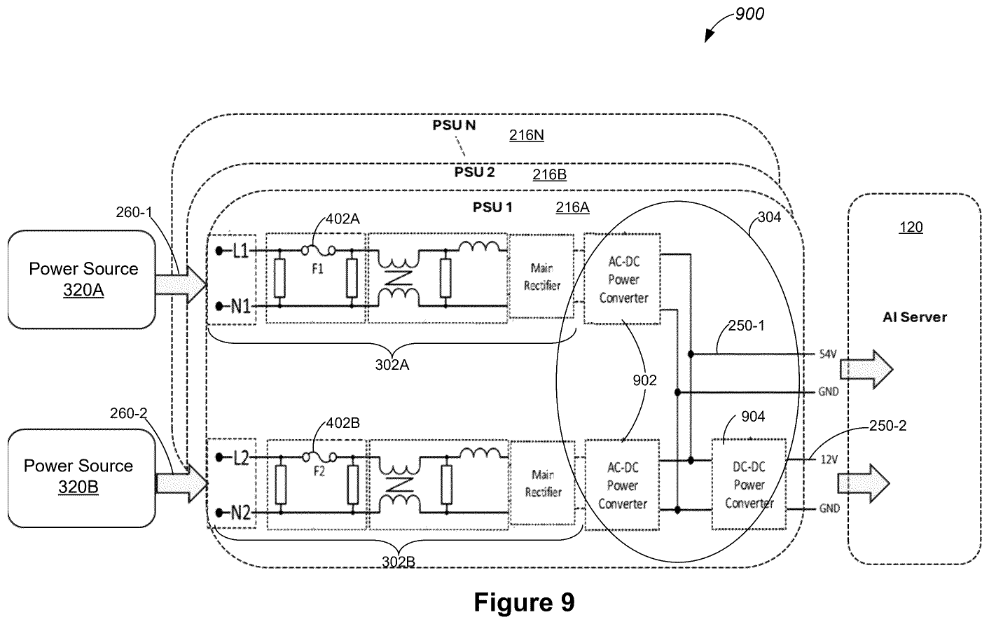

FIG. 9 is a block diagram of a server system 900 including a server 120 driven by a plurality of PSUs 216 (e.g., PSU 216A, 216B,. 216N), in accordance with some embodiments. Each PSU 216 is coupled to two external power sources 320A and 320B. Each PSU 216 includes two power interfaces 302A and 302B, a power converter 304, and a controller 306 (not shown). The power interfaces 302A and 302B are configured to receive two power supply signals 260, e.g., from two power sources 320A and 320B. The power converter 304 is coupled to the two power interfaces, and is configured to generate two DC power supplies 250 (e.g., 54V, 12V) based on at least one of the two power supply signals 260. The two power interfaces 302 are controlled independently of one another to select at least one of the plurality of power supply signals 260 to generate two DC power supplies 250.

In some embodiments, each of the first power interface 302A and the second power interface 302B further comprises a power switch 402A or 402B, and the power switch 402A or 402B is configured to receive a respective power control signal from the controller 306 and enable the respective power interface 302A or 302B to provide the first power supply signal 260-1 or the second power supply signal 260-2 to the power converter 304.

In some embodiments, the power converter 304 includes two AC-DC power converters 902 and a DC-DC power converter 904. The two AC-DC power converters 902 converts the AC power supply signals 260 to the first DC power supply 250-1 (e.g., 54V), which is further converted to the second DC power supply 250-2 (e.g., 12V). In some embodiments, the two power supplies 250 include a first DC power supply 250-1 (e.g., +54V) and a second DC power supply 250-2 (e.g., +12V) lower than the first DC power supply. In some embodiments not shown, the second DC power supply 250-2 may be generated from the AC power supply signals 260 (e.g., 400 DC voltage). Alternatively, in some embodiments (FIG. 9), the second DC power supply 250-2 may be generated from the first DC power supply 250-1, e.g., by a buck converter.

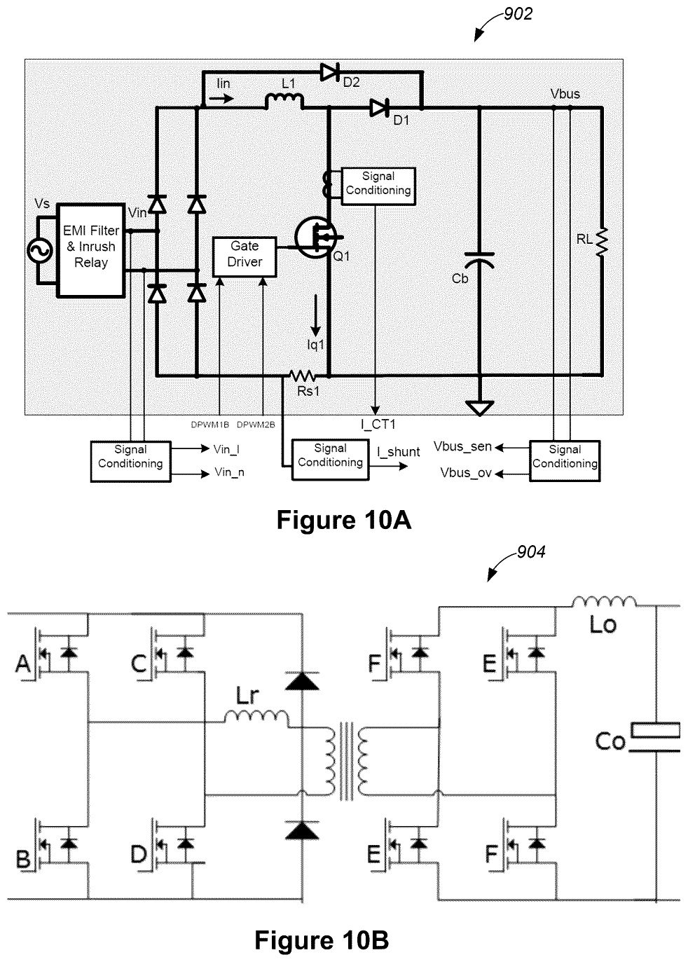

FIG. 10A is a schematic diagram of an example power interface 302A or 302B used in a PSU 216 shown in FIG. 9, in accordance with some embodiments, and FIG. 10B is a schematic diagram of an example AC-DC converter 902 used in a PSU 216 shown in FIG. 9, in accordance with some embodiments.

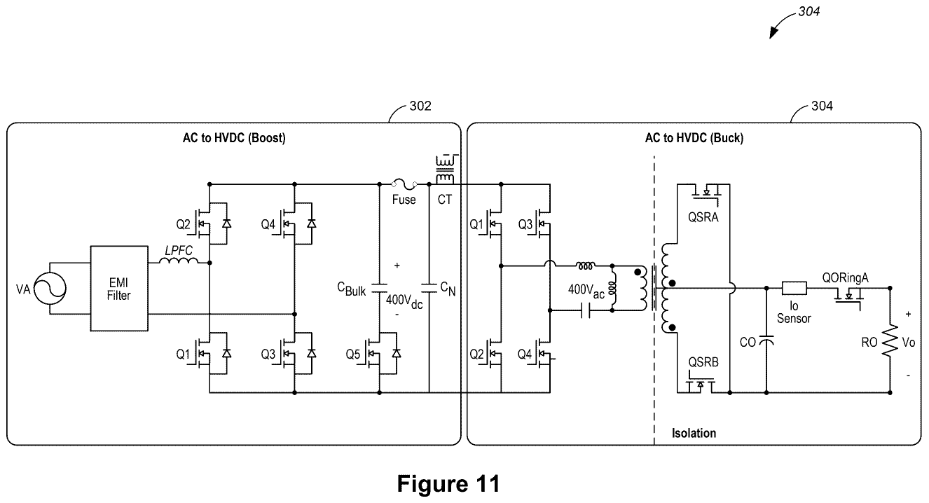

FIG. 11 is a schematic diagram of an example PSU 216 including a power interface 302 and a power converter 304, in accordance with some embodiments. The power interface 302 includes a power factor convertor coupled to an AC power supply signal 260 (e.g., 110 or 220V). The power interface 302 coverts the AC power supply signal to a 400V DC power supply. The power converter 304 is coupled to the power interface 302, and configured to further generate a DC power supply 250 based on the 400V DC power supply, e.g., using a buck converter. More details on the power interface 302 and the power converter 304 are discussed above with reference to at least FIGS. 3A-4.

The terminology used in the description of the various described implementations herein is for the purpose of describing particular implementations only and is not intended to be limiting. As used in the description of the various described implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. Additionally, it will be understood that, although the terms “first,” “second,” etc. may be used herein to describe various elements, these elements should not be limited by these terms. These terms are only used to distinguish one element from another.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,”depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

Although various drawings illustrate a number of logical stages in a particular order, stages that are not order dependent may be reordered and other stages may be combined or broken out. While some reordering or other groupings are specifically mentioned, others will be obvious to those of ordinary skill in the art, so the ordering and groupings presented herein are not an exhaustive list of alternatives. Moreover, it should be recognized that the stages can be implemented in hardware, firmware, software or any combination thereof.

What is claimed is:

1. An electronic system, comprising:
a first power interface for receiving a first power supply signal;
a second power interface for receiving a second power supply signal;
a power converter coupled to the first power interface and the second power interface, wherein the power converter is configured to generate a plurality of DC power supplies based on at least one of the first power supply signal and the second power supply signal; and
a controller coupled to at least the first power interface and the second power interface, wherein the controller is configured to select the at least one of the first power supply signal and the second power supply signal via the first power interface and the second power interface independently of each other to be input into the power convert for generating the plurality of DC power supplies.

2. The electronic system of claim 1, wherein each of the first power interface and the second power interface further comprises a power switch coupled to the controller, and the power switch is configured to receive a respective power control signal from the controller and connect the respective power interface to provide the first power supply signal or the second power supply signal to the power converter.

3. The electronic system of claim 1, wherein the plurality of DC power supplies includes a target DC power supply, and the power converter further includes an output component configured to receive, at a filter input, both a first target supply generated based on the first power supply signal and a second target supply generated based on the second power supply signal and generate the target DC power supply.

4. The electronic system of claim 3, wherein the output component includes a filter configured to filter the target DC power supply.

5. The electronic system of claim 3, wherein:
the power converter further includes two voltage converter portions coupled to the first power interface and the second power interface, respectively;
the two voltage converter portions are configured to generate the first target supply and the second target supply, respectively; and
the first target supply and the second target supply are coupled to each other at outputs of the two voltage converter portions.

6. The electronic system of claim 1, wherein the plurality of DC power supplies includes one or more of:
a first DC power supply is enabled in response to detection of an incoming processor request for the first DC power supply; and
a second DC power supply is enabled, independently of whether an incoming processor request is received for the second DC power supply.

7. The electronic system of claim 1, wherein:
each of the first power interface and the second power interface includes an electromagnetic interference (EMI) component for controlling an EMI level in a respective power supply signal and a passive filter for controlling a noise level of the respective power supply signal; and
the power converter further includes two voltage converter portions, and each voltage converter portion is coupled to the respective power interface and includes a respective voltage conversion circuit.

8. The electronic system of claim 1, wherein each of the first power supply signal and the second power supply signal includes a respective DC input supply signal.

9. The electronic system of claim 1, wherein the controller is configured to select the at least one of the first power supply signal and the second power supply signal by:
in accordance with a determination that a power consumption level is lower than a first power threshold, disabling the second power interface, and enabling the first power interface.

10. The electronic system of claim 1, wherein the controller is configured to select the at least one of the first power supply signal and the second power supply signal by:
enabling the first power interface; and
in accordance with a determination that a power consumption level is greater than a first power threshold, enabling the second power interface.

11. The electronic system of claim 10, wherein the controller is configured to, when the first power interface and the second power interface are both enabled:
control the first power interface and the second power interface to provide the first power threshold and a remainder of the power consumption level, respectively.

12. The electronic system of claim 11, wherein the controller is configured to, when the first power interface and the second power interface are both enabled:
in accordance with a determination that the remainder of power consumption level is greater than the first power threshold, controlling the first power interface and the second power interface to provide the power consumption level substantially evenly.

13. The electronic system of claim 1, wherein the controller is configured to, when the first power interface and the second power interface are both enabled, control the first power interface and the second power interface to provide substantially equal portions to a target power consumption level.

14. The electronic system of claim 1, wherein the controller is configured to, when the first power interface and the second power interface are both enabled, control the first power interface and the second power interface to provide two respective power portions to a target power consumption level, and the two respective power portions having a fixed ratio.

15. The electronic system of claim 1, wherein:
the first power supply signal corresponds to an alternating current signal having a first phase; and
the second power supply signal corresponds to an alternating current signal having a second phase that is offset from the first phase by one-third of a power signal cycle.

16. The electronic system of claim 1, wherein:
the first power supply signal corresponds to an alternating current signal having a first phase; and
the second power supply signal corresponds to an alternating current signal having a second phase that is synchronized with the first phase.

17. The electronic system of claim 1, further comprising:
one or more power interfaces each of which is configured to receive a respective and distinct power supply signal, wherein the first power interface, the second power interface, and the one or more power interfaces are distributed substantially evenly among three thirds of a power signal cycle.

18. The electronic system of claim 1, further comprising one or more of:
a power supply component having a power supply housing that encloses the first power interface, the second power interface, the power converter, and the controller;
memory storing one or more programs for execution by the one or more processors;
one or more processors; and
a system housing for enclosing the one or more processors, the memory, and the power supply component.

19. A power supply, comprising:
a first power interface for receiving a first power supply signal;
a second power interface for receiving a second power supply signal;
a power converter coupled to the first power interface and the second power interface, wherein the power converter is configured to generate a plurality of DC power supplies based on at least one of the first power supply signal and the second power supply signal; and
a controller coupled to at least the first power interface and the second power interface, wherein the controller is configured to select the at least one of the first power supply signal and the second power supply signal via the first power interface and the second power interface independently of each other to be input into the power convert for generating the plurality of DC power supplies.

20. A method for providing power to a server, comprising:
receiving a first power supply signal;
receiving a second power supply signal;
while controlling the first power interface and the second power interface independently of each other, selecting at least one of the first power supply signal and the second power supply signal;
generating a plurality of DC power supplies based on the at least one of the first power supply signal and the second power supply signal.
